(19) United States
(12) Patent Application Publication
(10) Pub. No.: US 2014/0058940 A1
(43) Pub. Date: Feb. 27, 2014

(54) REMOTE DEPOSIT CAPTURE INTERNET DEPOSIT APPLICATION

(71) Applicant: Cachet Financial Solutions, Inc., Minneapolis, MN (US)

(72) Inventor: Christopher F. Ebbert, Minneapolis, MN (US)

(73) Assignee: Cachet Financial Solutions, Inc., Minneapolis, MN (US)

(21) Appl. No.: 13/972,206

(22) Filed: Aug. 21, 2013

Related U.S. Application Data
(60) Provisional application No. 61/691,562, filed on Aug. 21, 2012.

(51) Int. Cl. G06Q 20/10

(52) U.S. Cl. CPC G06Q 20/108
USPC 705/42

(57) ABSTRACT

A remote deposit capture system, comprising, a server adapted for centralized receipt of remote capture deposit transactions, a financial institution system adapted for receipt of remote capture deposit transactions information from said server and for crediting accounts based thereon, an internet deposit application adapted for communication with said server and for digital acquisition and processing of checks, and a digital acquisition device adapted for communication with said application and for capturing of checks.

### RELATED APPLICATION

This application claims priority to and incorporates by reference United States Provisional Patent Application No. 61/691,562 filed on Aug. 21, 2012 of the same title.

### BACKGROUND

1. Field of the Invention

This invention relates to a remote deposit capture method and apparatus. In particular, the invention relates to a method and apparatus for remote deposit capture of a financial instrument using a series of commands embedded in web pages that comprises an internet deposit application (“IDA”) that interface with a scanning/photographic device attached or embedded into a computing device. Of course, a person of ordinary skill in the art will understand that the invention is not necessarily so limited. 2. Background of the Invention

Remote Deposit Capture (“RDC”) had been termed one of the most important developments the banking industry has seen in years. The Federal Reserve, nearly all of the top banks in the US, as well as other important financial institutions have either endorsed or launched RDC services.

In general, terms, RDC is a service that allows a user to scan or digitally reproduce checks or other financial instruments and transmit the images to a financial institution for posting and clearing. The basic requirements for an RDC service currently include a user computing device, an internet or network connection, a check scanner/digital camera, and a RDC service provider such as a financial institution or a third party provider working with the financial institution. Financial instruments, such as checks, are digitized to create a digital image. This digital image is then transmitted (usually over an encrypted internet connection) to a RDC processor and is then eventually cleared for deposit.

The advantages of RDC are many. For businesses, the advantages include accelerated clearings, improved availability of banking services, enhanced cash flow, reduced costs, and consolidation of banking relationships. Similarly, RDC is beneficial to financial institutions by providing them with reduced transportation costs, new revenue streams and customers, and reduced processing and clearing costs. Consumers/users also benefit because they do not have to physically travel to a financial institution, and can conduct business with any institution and not just those located nearby.

RDC does suffer from significant drawbacks. In particular, the hardware systems utilized for RDC transactions can and will vary making it difficult to develop software and systems that adequately interface with all hardware devices and configurations. Accordingly, a need exists for a RDC system that overcomes the difficulties of the prior art by providing a system the can more easily interface with various computing devices and operating systems.

### SUMMARY OF THE INVENTION

An object of the present invention is to provide a RDC system that substantially eliminates the problems of the prior art. These and other objects of the present invention will become apparent to those skilled in the art upon reference to the following specification, drawings, and claims. To that end, the present invention comprises a remote deposit capture system, comprising, a server adapted for centralized receipt of remote capture deposit transactions, a financial institution system adapted for receipt of remote capture deposit transactions information from said server and for crediting accounts based thereon, an internet deposit application delivered as code embedded in one or more web pages delivered from a web server to a users computing device for digital acquisition and processing of checks, and a digital acquisition device adapted for communication with said application and for capturing of checks.

### BRIEF DESCRIPTION OF DRAWINGS

FIG. 1 is an IDA flow chart.

FIG. 2 is a scanning/photo flow chart.

FIG. 3 is a cancel scan/photo flow chart.

FIG. 4 is an IDA connections block diagram.

### DETAILED DESCRIPTION OF THE PREFERRED EMBODIMENTS

The present invention relates to a method and apparatus for remote deposit capture as described herein. The invention makes use of an IDA that a user utilizes through a web interface and is comprised of code embedded in web pages accessed via a conventional web browser, wherein the web interface is provided remotely by a server.

The user triggers the launch of the IDA by responding to a prompt such as “Make New Deposit” on the web interface. The IDA is then delivered and executed through embedded coded in one or more web pages provided from the server locally to the user's computer. Alternatively, the IDA (or some portion thereof) may already reside on the local computer as a result of a prior use, and in which case the embedded application may launch locally.

During execution the IDA receives certain information, including configuration settings which can be comprised of one or more of the following: digital capture device type to be used (i.e. scanner or digital camera); any prior deposit information to be used or completed (if any); configuration of the deposit amount (either auto balance or user balance—described in detail below); settings to control whether duplicate checks are allowed, and settings for determining if users can edit certain fields (such as ABA routing number, account number, check number, check amount, or how to handle the situation if the check fields cannot be fully read); and various other configuration parameters (like adding or setting logos, colors, fonts, and the like).

After configuration, the IDA assesses the state of the digital capture device, for example, a scanner. If the scanner cannot be found, an error is presented and the user is not allowed to scan any new checks, but the user can still edit a deposit (if one was sent down for edit by the server). The scanner can be declared a “load from local file” status, which would then allow the IDA to proceed without a physical scanner and instead process image files from other sources such as files stored on a hard drive.

After the state of the digital capture device is determined, the user has the ability to: scan new checks; remove checks that have already been scanned (from either a recent scan or an edited deposit); or close the deposit and terminate the session.

Next, the user is ready to start to scan checks by selecting a “Scan” prompt displayed by the IDA. Based on the type of scanner/device connected, the following will occur: Twain-compliant scanner—the user will be prompted to scan the front and then the back of the check, then once that is completed, the user will be able to scan a subsequent check; single-feed check scanner—the scanner will scan one check, and once that is completed, the user will be able to scan a subsequent check; multi-feed check scanner—the scanner will scan all of the checks in the batch, and once that is completed, the user will be able to scan a subsequent batch; or if no scanner is attached—the user will be prompted to find the local file of the front and then the back of the check, and upon completion the user will be able to prompted to load a subsequent check.

After every scanned check has been entered, the information about the check (image, MICR (if available from a dedicated check scanner)) is sent to the server. After the server performs recognition operations and is finished processing the check, the server passes down the information obtained thereby, including, the ABA, account number, check number, MICR (if not previously obtained), and amount on the check.

If server cannot identify any of the required fields then the user is allowed to update the values manually through the “Update” button (provided the user has been authorized), or processing will remain incomplete and the IDA will stop closing of the deposit until the check is removed (provided the user does not or cannot make the foregoing corrections).

The IDA also provides the ability for the user, provided they have been given authorization, to remove checks that have been scanned (from either a recent scan or an edited deposit). A user can remove a check from the list of checks that have been previously scanned by clicking on the red ‘X’ next to the list of checks.

The IDA further provides the ability to close the deposit. Once the user is finished with scanning checks and editing the deposit, the deposit can be closed by selecting the “Complete” button. The deposit will be considered complete if the user entered sum of the checks matches the value determined by the system (if applicable). If the value is not the same, the user may have the ability to update the user balance to match (ability depends on authorizations granted by the system administrator through admin configuration settings).

A check is also considered incomplete if it is missing the ABA, account number, check number, or amount. If the deposit is not considered complete, then the user must edit the deposit or the items until all error conditions are resolved (if granted authority) in order to complete the deposit.

More specifically, the present invention is described in references to the following figures and description. In the Figures, the functionality and description of the IDA is shown and described. The IDA includes areas reserved for a banner display, which can be customized for the user to include a corporate identified or other identifier. An area is reserved for a logo as well. A list of checks to be deposited is provided, and includes the check numbers, check amounts, and the status of the check (error status).

Each of the individual checks can be selected, which will then display a picture of the scanned or photographed check. Optionally, a feature next to the listing of the checks can be selected to toggle between displaying the front, back, or both sides of the check in a viewing area. Furthermore, the checks can be deleted (provided the user has been given edit authority) by selecting a delete feature adjacent to the listing of the checks.

The MICR data will appear since the application can read this information from the scanned/photographed image utilizing character recognition capability, or the information can be provided by the scanner. The check information is interpreted by character recognition software that can extract from the check the information written on the check. Typically, the recognition software runs on the server rather than the IDA, however, the invention is not so limited. Also, appearing adjacent to the image (provided the field can be interpreted) is the amount of the check in an editable field (in order to correct any errors in recognition—via the update feature that is described below).

A field is included to enter custom notes. The notes are typically entered by the user of the IDA for internal purposes as needed to associate information with processed checks. The notes are not sent with the image to the financial institution, but are kept in the system for storage and can be reviewed through searches. There can be any reasonable number of note fields (not just one field as is shown in the Figures).

A total showing the number of deposit items as well as a total for all the items is provided. The IDA also shows the scan feature, update feature, and the complete feature that submits the items appearing on the screen for deposit. The scan feature is used to actually initiate the image scan of the check(s).

The update feature is used to correct the data appearing above the notes field, such as the MICR data, the check amount, and the like. In the event that the software fails to properly interpret the check, the user can correct the data using the update feature. The IDA provides configurable settings to allow control over which users have access to the update function, and how much access they have (i.e. which data fields they can correct).

The IDA can also be configured to display the user's location. Typically, the user will be a merchant, or some type of entity that receives checks from customers. The user can enter its location, and in the case of users with multiple locations, the IDA will allow the user to select between multiple locations. The IDA stores the location information as part of the operation of the software, and the location is used to create an ID associated with the check.

The IDA is configurable between an auto balance and user balance mode. In the auto balance mode, the checks are processed without a predetermined balance and there is no verification that the checks meet any requirements in terms of total amount. In the user balance mode, the user can enter in a total balance for one or more checks. Then the checks are scanned and processed. The IDA will issue an error if the total of the checks as determined by the IDA does not match the balance inputted by the user. This serves as a way to detect any problems in the ability of the IDA to recognize the check amounts and can alert the user to possible missing checks or checks that were not scanned because they stuck together in a multi-document type scanner.

Further error detection is included in the IDA as well. For example, the IDA will search for duplicate checks to prevent the same check from being scanned and deposited more than once. Also, the IDA creates a watermark that it places on the image that indicates that the check has been processed (similar in purpose to the stamp placed on a check manually by a bank teller).

Additional screens include a login screen that appears before the IDA launch that requests that the user enter a user name, and/or a password. A successful login launches the IDA. After the IDA launches, the user can then select a location (as described above). Next, the IDA will display a list of pending and submitted deposits associated with the user's location and/or account. The user can then submit any of the pending deposits, cancel transactions (provided they have been given authority by the IDA configuration settings controlled by a systems administer), or add new transactions. Adding new transactions will take the user to the operational screen described above.

All transactions are given a unique identifier by the IDA, which consists of a combination of the user's location id and a data/time stamp. In this manner, each deposit transaction can be uniquely identified.

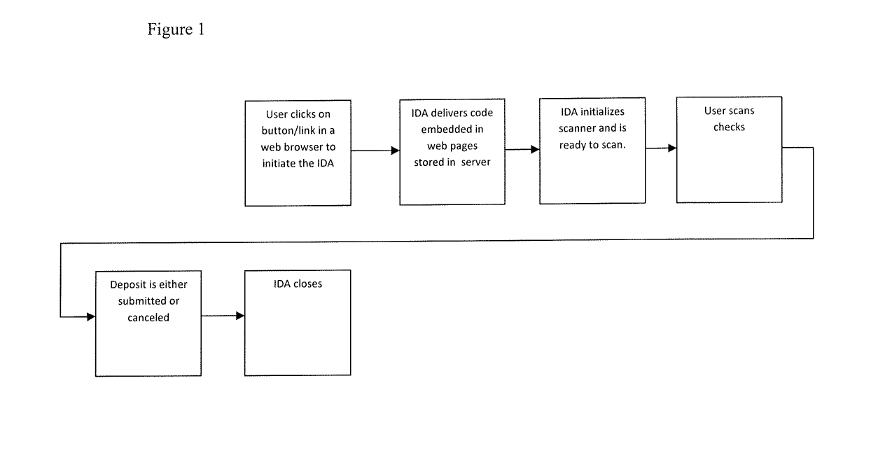

The flowchart in FIG. 1 discloses the workflow of the IDA. The first step involves having the user initiate the IDA preferably from a web browser or similar application. The

IDA can be run on a desktop computer, a handheld computing device, from a smart phone, tablet computer, or the like. The IDA includes interfaces to communicate with a variety of computing devices and operating systems, such as Android devices, iOS devices, Blackberry devices, and Windows 8 mobile devices. The IDA can be delivered, to the devices through code embedded in the web pages, the interfaces to necessary to communicate with the foregoing hardware, as well as the scanning or digitizing devices attached or affixed thereto.

After the IDA is initiated, the IDA delivers code necessary to perform the functionality described above through code embedded in web pages stored in a server which will process information from the computer running the IDA and interface with the computer of one or more financial institutions which hold the accounts which will receive the deposits.

The IDA then initializes the scanner, or alternatively a digital photographic device, or load images from the local computer that have been pre-scanned and stored. In one embodiment, a dedicated scanner can be attached to a desktop computer, but the invention is not necessarily limited. The IDA can communicate on a handheld device such as a smart phone or tablet computer with a built in scanner/camera.

Next, the user scans or photographs one or more checks for which processing is desired. The IDA then processes the image either successfully, or with an error, and the user has the option to either submit the check for deposit, cancel the transaction, or if the IDA detects a problem, the user can try again to scan/photograph the check.

Finally, once all the checks have been processed the IDA session is terminated and the application closes.

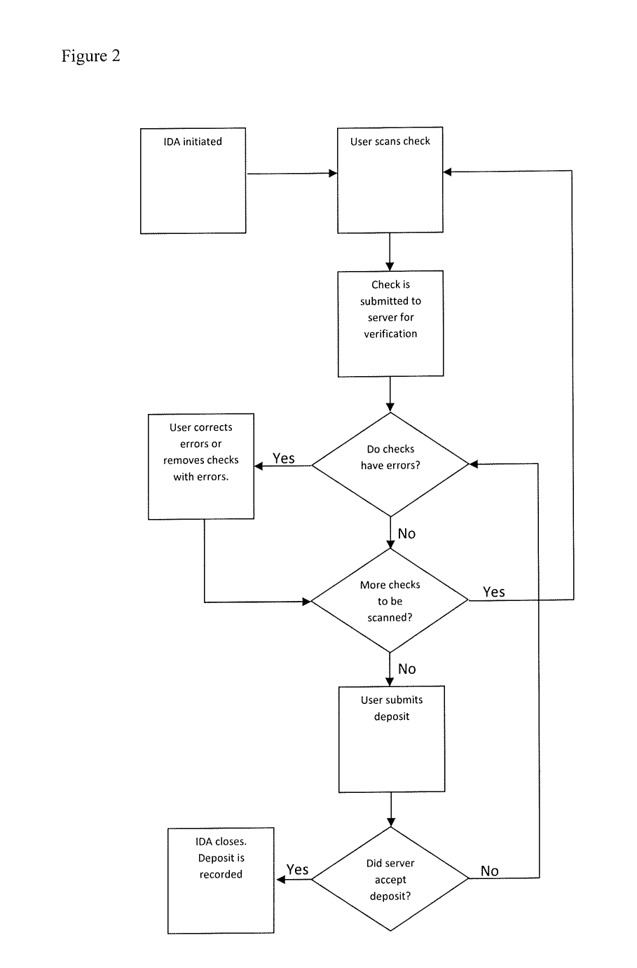

The flowchart in FIG. 2 outlines more specifically the process of scanning/photographing checks and making deposits. This entire process preferably happens within the operation of the IDA. Initially, the IDA is initiated as described above. The user then scans/photographs one or more checks. The images of the checks is submitted to the sever processing the checks on behalf of the financial institution for verification.

A determination in made as to whether the image can be properly processed. Some common types of the errors that the server may detect include (but are not limited to): cannot read MICR codes; cannot read check amount; check is a duplicate; check amount is too large; total deposit amount is too large; or deposit is empty. If an error is detected, the user is given a chance to correct any errors that are within the user authorization level to correct, and the check is reprocessed.

After the checks are scanned/photographed, the user submits the check for processing and deposit into one or more accounts at the applicable financial institution(s). The server processing the transactions on behalf of or through the financial institution returns an accepted or rejected message, prompting the IDA to either terminate the application if the transaction has been completed, or returning control to the errors decision step in case the transaction is not accepted by the server.

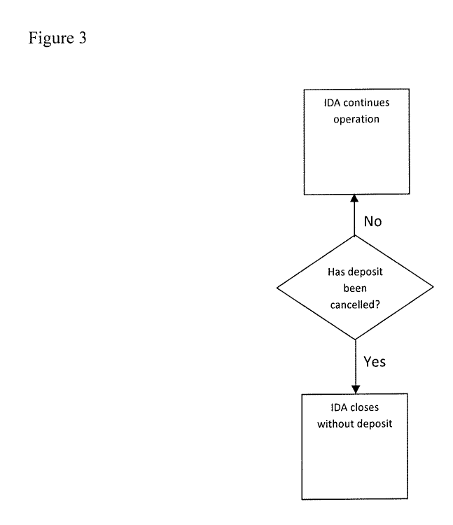

FIG. 3 outlines the cancel feature of the IDA. At any time during the operation of the IDA as described above, the user can cancel the operation and close the IDA. If the user does not cancel, then the IDA continues to operate. Cancelling can be done by closing the application or selecting the cancel button or the like.

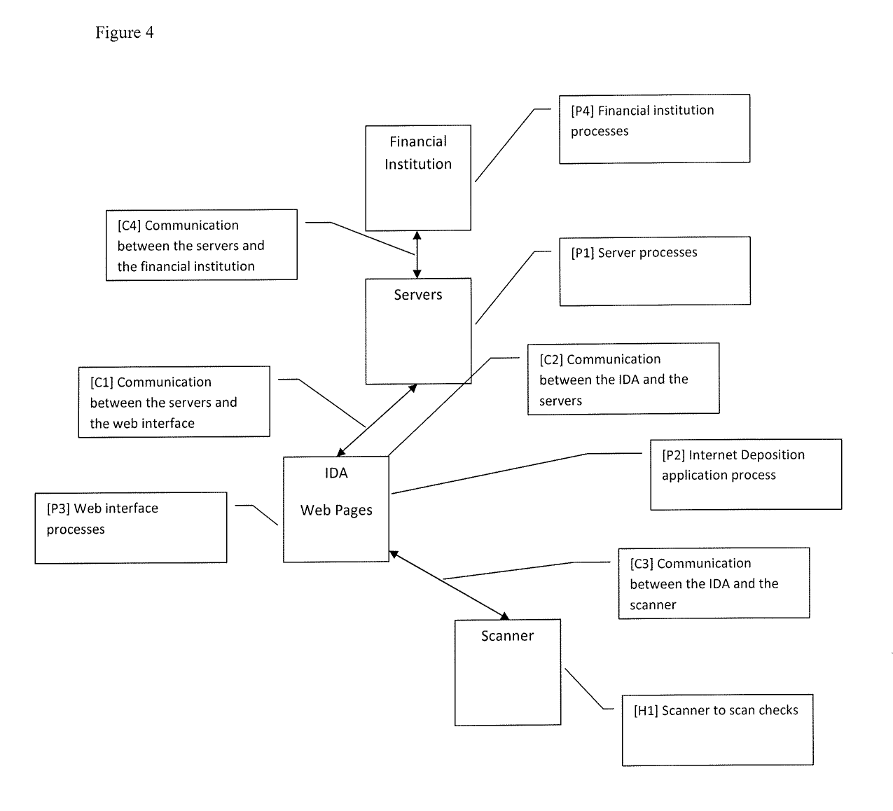

FIG. 4 discloses the interconnections between the servers, the IDA, as well as other hardware and software components used in combination with the IDA for the purpose of completely remote deposit transactions. FIG. 4 discloses the ability to initiate the IDA through code embedded in one or more web pages.

The server typically provides a connection between the IDA and the computer systems of the financial institutions to which the deposits are directed. The server typically would be remotely located from the financial institution and have the ability to service several such institutions. Or course, alternative placement of the server is also possible

[P1] This identifies one or more server processes that manage/record the deposits and submit the final deposit to the financial institution. In FIG. 4, the server processes also include the web server that will serve the web pages, and therefore the IDA. In addition to being able to initiating the IDA, the web servers also provide interfaces for username/password logins, historical data of deposits and research capability (searching of records).

[P2] This shows the IDA as described herein.

[P3] This shows the web interface that will initiate and in fact comprise the IDA and provides the interface to the server, and the server functionality.

[P4] This shows the financial institution servers/processes, which ultimately receives the remote deposit capture transaction and credits it to the appropriate account or accounts, and/or the core system or process that will submit the check data to a processing center or the Federal Reserve.

[C1] This shows the communication link between the servers and the web interface for the exchange of information described in reference to P1 and P3.

[C2] This shows the communication link between the IDA and the server for the exchange of information described in reference to P1 and P2, such as deposit information (image data, account numbers, check amounts, ID numbers), and error codes among other information.

[C3] This shows the communication link between the scanner/digital camera and the IDA for transfer of the images of checks, and MICR data (if the scanner can read MICR data).

[C4] This shows the communication link between the servers and the financial institution for the exchange of check information and images in a know format (e.g. X9.37 or other format).

[H1] This shows the scanner that can be any image scanner that is Twain compliant or a dedicated check scanner (alternately, no scanner can be used and images can be loaded locally). The communication is generally done through a USB cable. Alternatively, a digital camera that produces a digital photographic image can be used as well.

In this manner the system of the present invention substantially overcomes the limitations of the prior art.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A remote deposit capture system comprising;
a device for capturing an image of an image of a financial instrument; and
an internet deposit application for processing the image and executing a remote deposit transaction of the financial instrument depicted in the image.

2. The system of claim 1 wherein the internet deposit application is initiated by a user selecting the application from a web page.

3. The system of claim 1 wherein the internet deposit application is delivered to a computing device for execution through code embedded in web pages.

4. The system of claim 1 wherein the internet deposit application controls the operation of the device that captures the image of the financial instrument.

5. The system of claim 1 wherein the internet deposit application creates a data file containing information contained in the image.

6. The system of claim 5 wherein the internet deposit application performs verification operations on the image or the data file.

7. The system of claim 6 wherein if the verification fails a user can rescan the financial instrument.

8. The system of claim 6 wherein if the verification fails a user can correct the data in the data file.

9. The system of claim 1 wherein executing a remote deposit transactions includes depositing funds into an account at a financial institution.

10. The system of claim 6 wherein verification comprises verifying one or more of the following: the amount of the financial instrument, if the financial instrument is a duplicate, the total number of financial instruments, or if the image cannot be interpreted.

11. The system of claim 1 comprising a notes field to allow a user to enter notations associated with the financial instrument.

12. The system of claim 1 wherein the device is a dedicated scanner.

13. The system of claim 1 wherein the device comprises a digital camera.

14. The system of claim 1 wherein a digital watermark is used to mark the financial instrument.

15. The system of claim 1 wherein a user's location is captured.

16. The system of claim 1 wherein the internet deposit application creates a unique identifier associated with a remote deposit transaction.

17. The system of claim 16 wherein the identifier comprises a combination of a user's location and a data/time stamp.

18. The system of claim 1 wherein the remote deposit transaction is executed by a financial institution.
